(19) United States
(12) Patent Application Publication
(10) Pub. No.: US 2009/0084297 A1
(43) Pub. Date: Apr. 2, 2009

(54) SELF-SUSTAINING DATA CENTER OPERATIONAL TO BE EXTREMELY RESISTANT TO CATASTROPHIC EVENTS

(75) Inventors: Kenneth Choi, Montara, CA (US); Anna Falche, Oakland, CA (US); Richard Naughton, San Diego, CA (US)

Correspondence Address: PATTON BOGGS LLP, 1801 CALFORNIA STREET, SUITE 4900, DENVER, CO, 80202, US

(73) Assignee: KAR LLC, San Francisco, CA (US)

(21) Appl. No.: 11/864,036

(22) Filed: Sep. 28, 2007

(51) Int. Cl. B63B 17/00; B63B 35/00; E02B 3/20; G06F 17/30

(52) U.S. Cl. 114/56.1; 405/218; 707/10; 707/104.1; 707/E17.001; 114/343

(57) ABSTRACT

The Self-Sustaining Data Center makes use of a site that is inherently immune to catastrophic events and incorporates features to facilitate the substantially continuous availability of data stored therein. The architecture of the Self-Sustaining Data Center makes use of multiple data communication links to sites that are remote from the data center to enable the uninterrupted communication access of customers' computer systems to the mass storage systems operational at the Self-Sustaining Data Center. The Self-Sustaining Data Center also includes facilities that include at least one of: power generation, housing and food for data center staff, and voice communications facilities, thereby to enable the Self-Sustaining Data Center to continue its operation for an extended period of time in the absence of municipal utility services and the possible inability of the data center staff to access outside sources of food and water.

### FIELD OF THE INVENTION

This invention relates to the field of data centers where mass storage systems archive data for customers in a secure and reliable mode to ensure substantially continuous availability of the stored data to their customers in the event of an occurrence of a catastrophic event and also to ensure continued uninterrupted operation of the data center for a significant length of time.

### BACKGROUND OF THE INVENTION

It is a problem in existing data centers to securely store customers' data but to also ensure substantially continuous availability of this data to the customers in spite of the occurrence of a catastrophic event, whether natural in occurrence or man-made, and also whether localized or regional in scope. Most businesses can maintain a smooth business function only through a sustained data center operation, since their continued operation is predicated on the availability of large quantities of their data. With many businesses maintaining operations on a world-wide basis, the interruption of access to data at a particular site can have consequences to operations at many locations. Thus, businesses that have critical uptime needs must have access to data centers that maintain their data using a robust infrastructure, including data communication facilities that are substantially immune to failure or even short term interruption.

A major consideration in the design of such a data center is the avoidance of a single point of failure instance, where the failure of a single critical component can prevent customer access to the data stored in the data center or the continued operation of the data center. The catastrophic event can be natural in occurrence or man-made, and also localized or regional in scope. Regardless of the type of catastrophic event, the data center must remain immune to the effects of the catastrophic event, which immunity must be inherent in the design and operation of the data center.

The sustainability of a data center is a function of the physical security of the site, as well as its extreme resistance to catastrophic events that would impact the data center. The catastrophic events include natural disasters such as, but not limited to: earthquake, flood, tornadoes, wildfires, hurricanes, blizzards, landslides, and volcanic eruptions. While the selection of a site for placement of the data center can eliminate or significantly reduce the likelihood of the data center being subject to these natural disasters, there is not a locale that is totally immune from all natural disasters. Furthermore, even if the data center is not directly impacted by the natural disaster, the effects of a natural disaster can have a far-reaching impact in terms of loss of utilities: power, water, communications, food supply, etc. As a practical matter, data centers are best sited in locales proximate to the customers whom they serve, typically major metropolitan areas.

In addition, man-made or human-caused catastrophic events are more difficult to prevent. These human-caused catastrophic events can include fire, explosions, power outages, civil unrest, interruption of transportation facilities, or terrorist attacks. Again, while the selection of a site for placement of the data center can eliminate or significantly reduce the likelihood of the data center being subject to these human-caused catastrophic events, there is not a locale that is totally immune from all human-caused disasters. Furthermore, even if the data center is not directly impacted by the human-caused catastrophic event, the effects of a human-caused catastrophic event can have a far-reaching impact in terms of loss of utilities: power, water, communications, food supply, etc. As a practical matter, data centers are best sited in locales proximate to the customers whom they serve, typically major metropolitan areas.

Present data centers suffer from the inability to ensure substantially continuous availability of this data to the customers in the occurrence of catastrophic events, whether natural in occurrence or man-made, and also whether localized or regional in scope. Furthermore, even if the data center survives the catastrophic event, the continued uninterrupted operation of the data center cannot be ensured for any length of time. Thus, existing data centers all have limitations in one form or another that compromise their intended function and they fail to resolve the problems that were enumerated above.

### BRIEF SUMMARY OF THE INVENTION

The above-described problems are solved and a technical advance achieved by the present Self-Sustaining Data Center Operational To Be Extremely Resistant To Catastrophic Events (termed “Self-Sustaining Data Center” herein), which ensures substantially continuous availability of the stored data to their customers in the occurrence of catastrophic events and also ensures continued uninterrupted operation of the data center for a significant length of time.

The present Self-Sustaining Data Center makes use of a site that is inherently immune to catastrophic events and that incorporates design features to facilitate the substantially continuous availability of the data stored therein to the customers who own the data. The architecture of the Self-Sustaining Data Center makes use of multiple data communication links to sites that are remote from the data center to enable the uninterrupted communication access of customers' computer systems to the mass storage systems operational at the Self-Sustaining Data Center. In addition, the Self-Sustaining Data Center includes facilities that include at least one of: power generation, housing for data center staff, food for data center staff, and communications facilities other than data communication links, thereby to enable the Self-Sustaining Data Center to continue its operation in the absence of municipal utility services and the possible inability of the data center staff to access outside sources of food and water.

The Self-Sustaining Data Center is housed on specially designed marine vessels (also termed “waterborne craft” herein), which are immune to most catastrophic events of natural origin. The data center thereby offers convenient, disaster-proof storage for a company's most critical information. The Self-Sustaining Data Center offers the most practical solution for any business that values their information enough to securely preserve it, since it implements state of the art data center facilities that can be located at most ports.

No other data center has the capability to be fully self-sustaining for up to 12 months or offers higher levels of operating environment security. In the event of a terrorist attack or natural disaster, the Self-Sustaining Data Center is not forced off-line. With these capabilities, a business can safeguard their most important assets and avoid losing data worth millions of dollars in revenue. Furthermore, from a civic perspective, the Self-Sustaining Data Centers serve as the only truly safe disaster-relief municipal and communication center.

### BRIEF DESCRIPTION OF THE DRAWINGS

FIG. 1 illustrates a perspective view of a typical installation and architecture of a Self-Sustaining Data Center;

FIG. 2 illustrates a typical data management system which can be implemented in the present Self-Sustaining Data Center;

FIG. 3 illustrates the use of multiple data communication links from the waterborne craft to communication sites that are remote from the Self-Sustaining Data Center;

FIG. 4 illustrates a cross-section view of a typical waterborne craft that can be used in the implementation of the Self-Sustaining Data Center; and

FIG. 5 illustrates, in flow diagram form, a typical operation of the data communication facilities selection process used in the implementation of the Self-Sustaining Data Center.

### DETAILED DESCRIPTION OF THE INVENTION

### Catastrophic Events

The sustainability of a data center is a function of the physical security of the site, as well as its imperviousness to catastrophic events that would impact the data center. The catastrophic events can be categorized as either natural disasters or human-caused events. These are events that cause significant destruction to the area of impact, as well as disruption of normal municipal services.

The natural disasters include, but are not limited to: earthquake, flood, tornadoes, wildfires, hurricanes, blizzards, landslides, and volcanic eruptions. While the selection of a site for placement of the data center can eliminate or significantly reduce the likelihood of the data center being subject to these natural disasters, there is not a locale that is totally immune from all natural disasters. Furthermore, even if the data center is not directly impacted by the natural disaster, the effects of a natural disaster can have a far-reaching impact in terms of loss of utilities: power, water, communications, food supply, etc. As a practical matter, data centers are best sited in locales proximate to the customers whom they serve, typically major metropolitan areas.

In addition, man-made or human-caused catastrophic events are more difficult to prevent. These human-caused catastrophic events can include fire, explosions, power outages, civil unrest, interruption of transportation facilities, and terrorist attacks. Again, while the selection of a site for placement of the data center can eliminate or significantly reduce the likelihood of the data center being subject to these human-caused catastrophic events, there is not a locale that is totally immune from all human-caused catastrophic events. Furthermore, even if the data center is not directly impacted by the human-caused catastrophic event, the effects of a human-caused catastrophic event can have a far-reaching impact in terms of loss of utilities: power, water, communications, food supply, etc. As a practical matter, data centers are best sited in locales proximate to the customers whom they serve, typically major metropolitan areas.

### Architecture of the Self-Sustaining Data Center

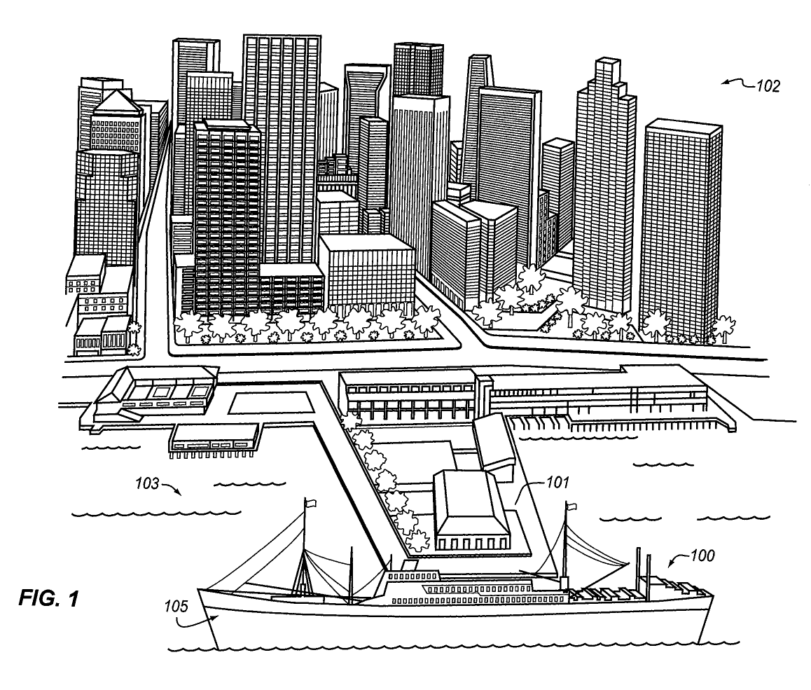

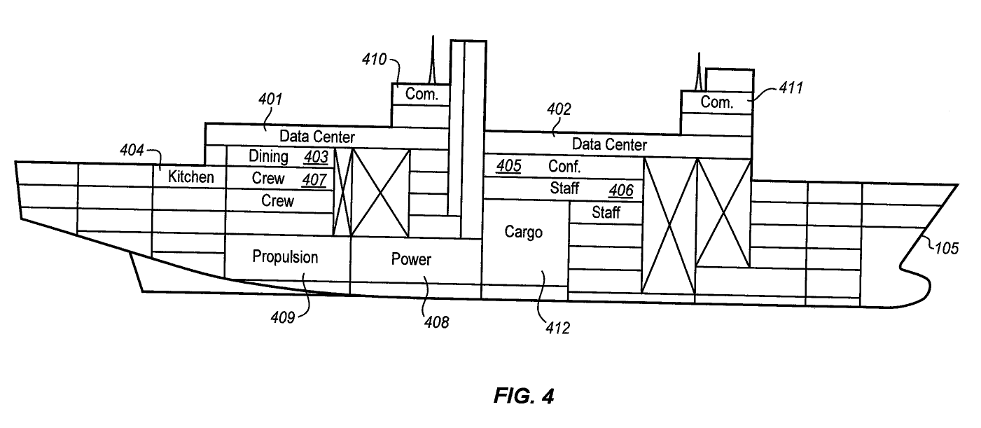

FIG. 1 illustrates a perspective view of a typical installation and architecture of a Self-Sustaining Data Center 100, wherein a waterborne craft 105 is used as the site for installing the mass storage system and data communications facilities (shown in FIG. 4) used to provide substantially continuous availability of stored data to customers in the occurrence of catastrophic events, and also to ensure continued uninterrupted operation of the data center for a significant length of time. Additionally, an emergency command center with berthing facilities is included in each vessel's configuration. The waterborne craft 105 typically is docked in a port 103 proximate to a metropolitan area 102. The port 103 typically is substantially immune to catastrophic events, especially those of a natural origin.

The waterborne craft 105 are marine vessels and can range from motorized vessels to manned barges that can be docked 101 in a port 103. The range of marine vessels that can be used is extensive, and the selection is a compromise among many variables including, but not limited to: cost, mobility, capacity for housing mass data storage systems and associated servers, capacity for supporting data communications facilities, power generation capacity, fuel storage capacity, housing for data center staff, water purification facilities, food storage and preparation facilities, and the like. The typical cost of docking a waterborne craft 105 in a port 103 is a fraction of the cost of land-based rental space in the associated metropolitan area 102. While the waterborne craft 105 selected typically remains docked at a fixed location, they may also contain propulsion apparatus to enable the waterborne craft 105 to relocate without external assistance from one dock location 101 to another. This also enables the waterborne craft 105 to move out of the path of the natural disaster (such as a hurricane) or to a more protected temporary location.

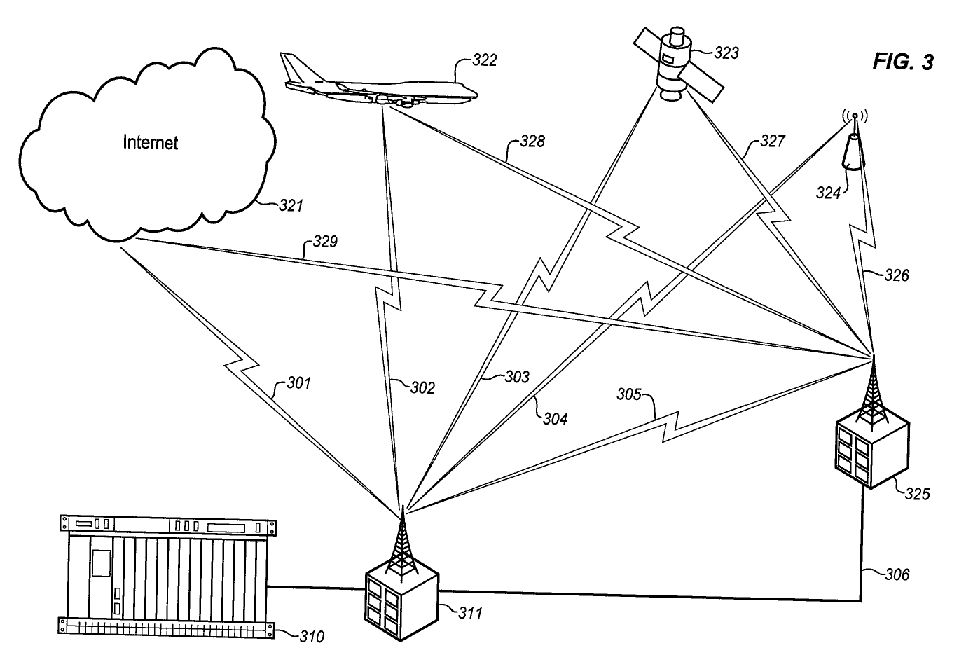

As illustrated in FIG. 3, the architecture of the Self-Sustaining Data Center 100 makes use of multiple data communication links 301-306 from the data communication facilities 311 located on board the waterborne craft 105 to communication sites (such as 321) that are remote from the Self-Sustaining Data Center 100 to enable the uninterrupted communication access of customers' computer systems to the mass storage systems 310 operational at the Self-Sustaining Data Center 100. The Self-Sustaining Data Center 100 also includes server hardware and software to regulate access to the data stored in the mass storage system 310, as well as data communications via the plurality of data communication links 301-306 to the sites that are remote from the Self-Sustaining Data Center 100.

The selection of the technology used to implement the data communication links 301-306 is influenced by the availability of facilities, ambient terrain, cost, data transmission capacity, diversity, and reliability. These issues are discussed in greater detail below.

### Self-Sustainability Aspects of the Self-Sustaining Data Center

FIG. 4 illustrates a cross-section view of a typical waterborne craft 105 that can be used in the implementation of the Self-Sustaining Data Center 100. The waterborne craft 105 of the Self-Sustaining Data Center 100 is provisioned with facilities that include at least one of power generation 408, housing for data center staff and visitors 406, housing for crew 407, food preparation and service 403-404, cargo hold 412 for the storage of supplies, communications facilities 411 other than data communication links, thereby to enable the Self-Sustaining Data Center 100 to continue its operation in the absence of municipal utility services and the possible inability of the data center staff to access outside sources of food and water. Thus, the waterborne craft 105 is self-sufficient in terms of the operation of the computer and data storage equipment, data communication facilities, and “life support” for the staff assigned to the waterborne craft 105 as well as individuals also on board, such as personnel from customers' operations.

The waterborne craft 105 shown is a motorized vessel but could be a manned barge. The waterborne craft 105 includes a propulsion system 409 and typically includes electric power generation capability as part of the boiler room 408. The waterborne craft 105 includes one or more data centers 401-402 for the storage and management of customer data. There are also communication facilities 410-411 of the type described herein to enable the communication of customer data between the waterborne craft 105 and on-shore facilities (not shown). The marine vessel used as the site for the Self-Sustaining Data Center 100 is equipped with antennas for supporting the radio frequency communications data links.

The Self-Sustaining Data Center site facilities, including mechanical, electrical, plumbing, and any other conditions that affect the sustainability of the site, are selected to render the Self-Sustaining Data Center 100 substantially immune to any catastrophic event that may occur. These facilities are also architected to continue uninterrupted operation for an extended period of time with little if any provisioning.

The disclosed implementation of the Self-Sustaining Data Center 100 provides a one-of-a-kind maritime data center for collocation and hosting of mission-critical business applications for those enterprises wanting “disaster recovery-business continuity safeguards”. The Self-Sustaining Data Center 100 also avoids the high lease rates prevalent in major cities, at the same time delivering an unmatched quality of service for clients who are located in and around these major cities. Since the majority of major metropolitan areas 102 are proximate to seaports, rivers, or inland bodies of water, the Self-Sustaining Data Center 100 can be used in the vast majority of metropolitan applications. Even if the customer locations are sited at a distance from a body of water, the use of satellite or wireless data communication links enable the Self-Sustaining Data Center 100 to serve these customer sites.

Thus, the Self-Sustaining Data Center 100 provides enterprises with a secure, always-on network with specialized DRBC (Data Recovery and Business Continuity) “hot” offices used in the event of a disaster. As part of a total package, the Self-Sustaining Data Center 100 also offers clients a secure environment that can be used for business continuity at a moment's notice, since the waterborne craft 105 typically is provisioned with living quarters, conference facilities, and dining facilities. The capabilities therefore include:

Class A office space with overnight accommodations;

Secure communications connecting you to your clients;

Onboard IT infrastructure supplies;

Integrated Command Center work space; and

Emergency berthing and dining facilities.

### Provisioned Customer Features and Services

The Self-Sustaining Data Center 100 can also include various novel services and facilities not found at existing data centers. These include, but are not limited to:
1. Dedicated collocation suites 405 for selected customers, with disaster recovery executive suites. These suites are complete with access to sleeping 406 and dining 403 facilities.
2. Secure, state-of-the-art shipboard data storage 401-402, transfer 410-411, and serving 403-404.
3. Unique self-sustainability to keep business flowing for more than one year following a natural disaster, terrorist attack, or unplanned long-term energy outage.
4. Cost-effective incremental scalability.
5. Around-the-clock availability using redundant infrastructures.
6. On-demand service delivery and load balancing.
7. An emergency command center is available for use to sustain operations and to train operations personnel.

### Communications Facilities

FIG. 3 illustrates the use of multiple data communication links 301-306 from the waterborne craft 105 to communication sites 321 that are remote from the Self-Sustaining Data Center 100. There are a number of classes of data communication facilities 301-306 available for use in implementing the data communication links: physical connections 306 (hard-wire link, fiber optic cables, and the like), point-to-point wireless communications 304-305, non-terrestrial communications 302-303, and other links 301 to a common carrier medium. The hard-wire links 306 can be a high-speed coaxial cable connection to a shore-based customer site, or a communication site that serves as a portal for access to the Self-Sustaining Data Center 100 by customers, or even a relay point in a private network that distributes data over subsequent data communication links to customers. A fiber optic cable performs the same function as the hard-wire link and is analogous to the hard-wire link in architecture and function. A point-to-point wireless link 304-305 can be implemented using a focused beam wireless microwave transmission 304 from an antenna located onboard the waterborne craft 105 to a land-based antenna 321 located at a communication site associated with the Self-Sustaining Data Center 100, a customer's communication site, or a point-to-point wireless radio frequency link 304 to a relay point 324 which then relays to communications via path 326 to another site, such as site 321. The range of the point-to-point wireless link 304-305 typically is dictated by the line-of-sight path between the two antennae. This limitation is eliminated by the use of a non-terrestrial radio frequency link that transcends the obstacles presented by the local terrain and buildings sited in the metropolitan area. The non-terrestrial radio frequency link 302-303 can be a link 303 to a satellite 323 and thence via link 328 to a ground station 321, or a link 302 to an aircraft-based communication platform and thence via link 327 to a ground station 321. The implementation of data communication links using any of these technologies is well known and not discussed further herein.

### Data Communications Management

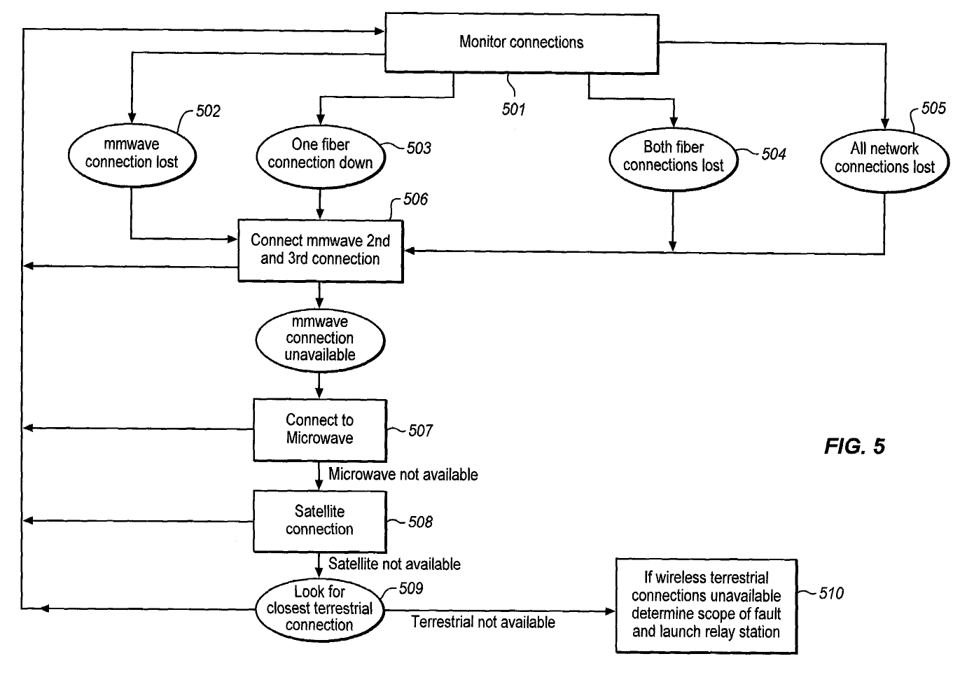

FIG. 5 illustrates, in flow diagram form, a typical operation of the data communication facilities selection process used in the implementation of the Self-Sustaining Data Center 100. In order to avoid a single point of failure issue, typically at least two different technologies are selected to implement a plurality of data communication links 301-306 to a plurality of communication sites 321, 326 to avoid a loss of communications due to the catastrophic event impacting one class of these communication facilities or one of the communication sites. In addition, these facilities may be linked together seriatim, such that a point-to-point wireless link 304 may connect the waterborne craft 105 with a communication site 324, which itself serves as a switching node on a private data communication network, with fiber optic links 326 extending from the communication site to customer facilities 321.

There are numerous data communication facilities management paradigms that can be implemented, and the following description is simply illustrative of the concept and is not intended to limit the breadth of the possible approaches that can be taken to implement this process. In FIG. 5, at step 501, the process is initiated to monitor the plurality of data communication links that are presently active. For the sake of example, the present data communication facilities are implemented using a wireless microwave link (such as link 305 in FIG. 3), and two fiber optic links (such as link 306 in FIG. 3) are presently active. As noted in step 501, these connections are monitored continuously for availability and quality of service. In the case where it is detected that the wireless microwave link fails (step 502), one of the wireless microwave links fails (step 503), both wireless microwave links fail (step 504), or all data communication links fail (step 505), then processing advances to step 506 where the data communication facilities management process at step 506 initiates connections to two alternate wireless microwave links. If this process is successful, then processing returns to step 501 where these facilities are monitored continuously.

If the alternate wireless microwave links are unavailable, then processing advances to step 507 where the data communication facilities management process initiates connections to a terrestrial radio frequency link (such as 304 in FIG. 3). If this process is successful, then processing returns to step 501 where these facilities are monitored continuously.

If the terrestrial radio frequency link is unavailable, then processing advances to step 508 where the data communication facilities management process initiates connections to a non-terrestrial data communication facility (such as link 303 to satellite 323 in FIG. 3). If this process is successful, then processing returns to step 501 where these facilities are monitored continuously.

If the satellite link is unavailable, then processing advances to step 509 where the data communication facilities management process initiates connections to a terrestrial data communication facility (such as link 306 in FIG. 3). If this process is successful, then processing returns to step 501 where these facilities are monitored continuously.

If the terrestrial link is unavailable, then processing advances to step 510 where an alternative communication facility, such as aircraft 322, is activated, and the data communication facilities management process initiates connections to this facility (such as link 302 to aircraft 322 in FIG. 3). If this process is successful, then processing returns to step 501 where these facilities are monitored continuously.

In all of these examples, when a data communication link is activated, a path duplication process typically is activated to secure an alternative data communication facility as a backup for the facilities that are presently activated. It is usual for these backup facilities to be of a type that does not duplicate the presently-used facilities. Thus, wireless microwave facilities may be backed up by a terrestrial link or a satellite link, for example. The management possibilities are numerous, and a detailed description of these possibilities is not provided in the interest of simplicity of description.

### Mass Data Storage Facilities and Data Management

The Self-Sustaining Data Center is equipped with data storage facilities, typically termed “mass storage systems”, which serve to store mass quantities of customer data. Such systems are well known and range from robotic tape cartridge storage libraries to RAID-based systems and can be used in conjunction with a Storage Area Network (SAN).

A tape cartridge library system can be characterized as providing the capability to automatically manage a plurality of mountable tape cartridges by the use of a robotic mechanism. These tape cartridge library systems include a plurality of storage locations for a corresponding tape cartridge. The robotic mechanism retrieves tape cartridges from their storage locations and mounts them in a tape drive, which operates under the control of a host computer, to read/write data on the tape cartridge that resides in the storage location media. Furthermore, a tape cartridge library system may comprise one or more modules that can operate in combination with one another to share access of tape cartridges.

In computing, a Storage Area Network (SAN) is an architecture to attach remote computer storage devices such as disk arrays, tape libraries, and optical jukeboxes to servers in such a way that, to the operating system, the devices appear as locally attached devices. Storage Area Networks also tend to enable more effective disaster recovery processes. A Storage Area Network attached storage array can replicate data belonging to many servers to a secondary storage array. This secondary array can be local or, more typically, remote. The goal of disaster recovery is to place copies of data outside the radius of effect of an anticipated threat.

By contrast to a SAN, network-attached storage (NAS) uses file-based protocols such as NFS or SMB/CIFS where it is clear that the storage is remote and computers request a portion of an abstract file rather than a disk block. The selection of the storage architecture does not impact the features noted above for the Self-Sustaining Data Center, but are noted to indicate the diversity of storage solutions that are available.

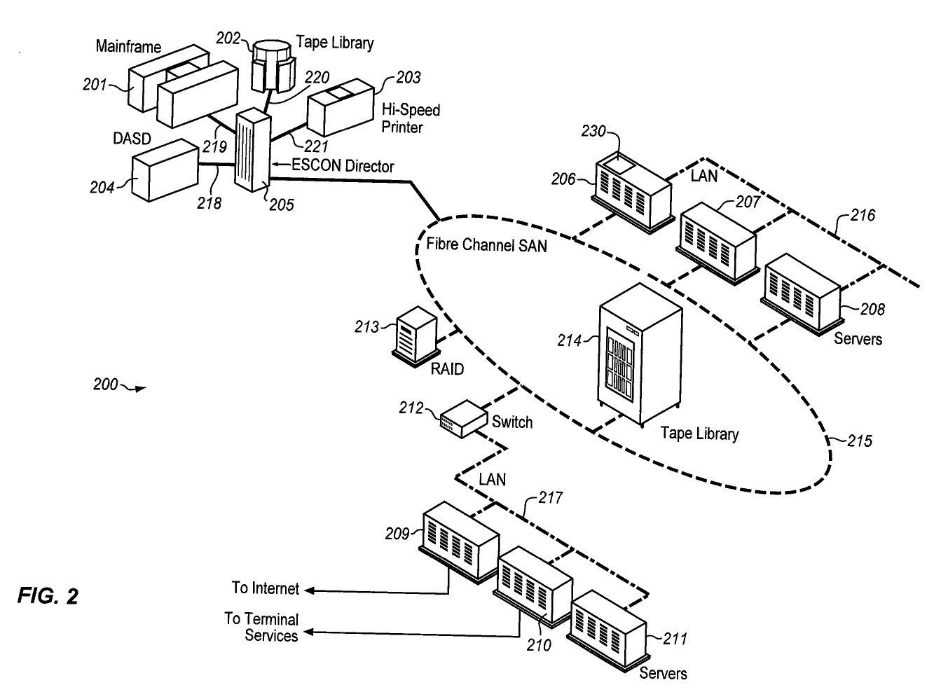

FIG. 2 illustrates a typical data management system environment which can be implemented in the present Self-Sustaining Data Center. This data management system architecture simply is illustrative of a typical configuration of computer processing resources, and is intended to illustrate the issues that are encountered in the proper processing, storage, and maintenance of information in a large organization. This description is not intended to limit the applicability of the present Self-Sustaining Data Center to other data management system environments and is solely intended to provide a framework for the accompanying description of the present Self-Sustaining Data Center.

Organizations have experienced a rapid growth in the volume of data that is required for their operation, as well as an associated increase in the time required to capture, store, process, and retrieve this data in a data management system 200. Increasing the speed of operation of the data management system 200 is critical to cost-efficient operation, as is the need to increase the efficiency at which data is exchanged among the data processors 201, 206-211 and data storage modules 202, 204, 213, 214 in the data management system 200. As shown in FIG. 2, a typical data management system installation can include a mix of the following elements: one or more mainframe data processors 201, 206-211; one or more automated tape cartridge library systems 202, 214; one or more DASD systems 204; one or more high speed printers 203; or one or more RAID data storage 213 systems. For example, some of these disparate modules 201-204 can be connected via channels 218-221 in a point-to-point manner to a director 205 which serves to interconnect these modules 201-204 as needed to distribute the data that is managed by the data management system 200. Alternate interconnection configurations are possible, and many data management systems use the Fibre Channel-based Storage Area Network (SAN) 215 and/or a Local Area Network (LAN) 216, 217 to interconnect multiple data processors 206-211 with I/O devices 213, 214 and/or other processor configurations. As shown in FIG. 2, a plurality of data processors 209-211 are interconnected via Local Area Network 217 with each other and a server 212, which serves as an interface to Fibre Channel-based Storage Area Network (SAN) 215. A Fibre Channel is a set of standards that define a multi-layered architecture that transfers data on a physical medium among interconnected data processing and I/O devices. One or more of the data processors 209 can serve as a router to interconnect data management system 200 to an external IP network, such as the Internet, to provide remote access to customers and personnel. One or more of the data processors 210 can serve data terminals that are located within the physical premises of the organization and data links (not shown) can interconnect remotely located data processors (not shown) with the elements shown in FIG. 2.

This description illustrates the complexity and extent of data management systems that can be used to support a large organization, as well as numerous smaller organizations, and provides examples of different interconnection architectures. The Self-Sustaining Data Center 100 offers the only maritime solution to the following services:
1. Network Storage And Backup;
2. Managed Firewalls And Security;
3. Managed Load Balancing Services;
4. Ethernet Data Services;
5. Alerts And Server Monitoring Processes;
6. Training Capabilities;
7. Web Application Server Hosting; and
8. Server Replication And Mirror Capabilities.

### Physical Security Aspects of Self-Sustaining Data Center

The physical security of the Self-Sustaining Data Center 100 is addressed by the use of a single point of access via a secure dock facility 101. The dock facility 101 typically includes an office manned around the clock to restrict access to the Self-Sustaining Data Center 100, with only authorized personnel being able to pass through the access portal. The personnel hired by the operators of the Self-Sustaining Data Center 100 would be screened and drug tested routinely to ensure the highest caliber personnel operating the Self-Sustaining Data Center 100.

Thus, the Self-Sustaining Data Center 100 offers customers:
1. Unparalleled Security;
2. Security office (on pier adjacent to Self-Sustaining Data Center 100) continuously manned by staff that are subject to random drug (urine) testing;
3. Use of bio-metric identification (iris scanning) for positive identification of the personnel, customers, and visitors prior to entry aboard the Self-Sustaining Data Center 100;
4. Top-of-the-line security fences, gates, and surveillance camera coverage;
5. RFID and motion detection tracking and monitoring of all personnel aboard the Self-Sustaining Data Center 100; and
6. U.S. Coast Guard licensed engineers aboard the Self-Sustaining Data Center 100 to operate the waterborne craft 105.

### SUMMARY

The present Self-Sustaining Data Center makes use of a site that is inherently immune to catastrophic events and incorporates design features to facilitate the substantially continuous availability of the data stored therein to the customers who own the data.

1. A self-sustaining data center for the secure storage of data for substantially continuous availability, comprising:
secure site for providing a locale that is immune to catastrophic events;
data storage system, located at said locale, for securely storing customer data for a plurality of customers; and
data communication system, located at said locale and linked to said data storage system, for providing a plurality of data communication links to communication sites not located at said locale; and
data access control, responsive to a remotely located customer requesting access to their customer data stored in said data storage system, for regulating access by said customer to said their customer data.

2. The self-sustaining data center of claim 1 wherein said secure site comprises:
waterborne craft docked in a seaport for housing said data storage system and said data communications means onboard said waterborne craft.

3. The self-sustaining data center of claim 2 wherein said waterborne craft comprises:
propulsion system for enabling said waterborne craft to relocate without external assistance from one docking location to another.

4. The self-sustaining data center of claim 2 further comprising:
access located on land adjacent to said waterborne craft for providing controlled access to said waterborne craft.

5. The self-sustaining data center of claim 2 wherein said waterborne craft comprises:
a vessel selected from the class of waterborne craft including, but not limited to, manned barges and motorized vessels.

6. The self-sustaining data center of claim 1 wherein said secure site comprises:
self-sustaining facilities including at least one of: self-contained power generation, housing for data center staff, food for data center staff and communications facilities other than said data communication system.

7. The self-sustaining data center of claim 6 wherein said communication facilities comprise:
voice communications links to enable individuals located at said site to communicate with individuals located at locations remote from said site.

8. The self-sustaining data center of claim 1 wherein said communication system comprises:
a plurality of data communication links implemented using at least two different data communication technologies.

9. The self-sustaining data center of claim 1 wherein said communication system comprises:
a plurality of data communication links implemented using at least two of hardwire, fiber, wireless point-to-point, and satellite communications.

10. The self-sustaining data center of claim 1 further comprising:
a plurality of land-based communication sites, each of which connects with at least one of said plurality of data communication links.

11. The self-sustaining data center of claim 10 further comprising:
wherein said data communication links are point-to-point links, each of which is directed to at least one of said plurality of land-based communication sites.

12. A method for implementing a self-sustaining data center for the secure storage of data for substantially continuous availability, comprising:
docking a watercraft at a locale that is substantially immune to catastrophic events;
installing data storage apparatus for securely storing customer data for a plurality of customers on said watercraft;
installing data communication links on said watercraft that are linked to said data storage apparatus for providing a plurality of data communication links to communication sites not located at said watercraft; and
regulating access, in response to a remotely located customer requesting access to their customer data stored in said data storage system, by said customer to said their customer data.

13. The method for implementing a self-sustaining data center of claim 12 further comprising:
providing, at a location on land adjacent to said waterborne craft, controlled access to said waterborne craft.

14. The method for implementing a self-sustaining data center of claim 12 further comprising:
providing self-sustaining facilities on said waterborne craft including at least one of: self-contained power generation, housing for data center staff food for data center staff, and communications facilities other than said data communication links.

15. The method for implementing a self-sustaining data center of claim 14 wherein said step of providing communication facilities comprise:
providing voice communications links to enable individuals located at said site to communicate with individuals located at locations remote from said site.

16. The method for implementing a self-sustaining data center of claim 12 wherein said step of providing communication links comprises:
implementing a plurality of data communication links using at least two different data communication technologies.

17. The method for implementing a self-sustaining data center of claim 12 wherein said step of providing communication links comprises:
implementing a plurality of data communication links using at least two of hardwire, fiber, wireless point-to-point, and satellite communications.

18. The method for implementing a self-sustaining data center of claim 12 further comprising:
installing a plurality of land-based communication sites, each of which connects with at least one of said plurality of data communication links.

19. The method for implementing a self-sustaining data center of claim 18 further comprising:
wherein said data communication links are point-to-point links, each of which is directed to at least one of said plurality of land based communication sites.
